(19) United States
(12) Patent Application Publication
(10) Pub. No.: US 2003/0046229 A1
(43) Pub. Date: Mar. 6, 2003

(54) Digital checkbook

(76) Inventor: William H. Cresswell, Corvallis, OR (US)

Correspondence Address: HEWLETT-PACKARD COMPANY, Intellectual Property Administration, P.O. Box 272400, Fort Collins, CO, 80527-2400, US

(21) Appl. No.: 09/943,911

(22) Filed: Aug. 31, 2001

(51) Int. Cl. G06F 17/60

(52) U.S. Cl. 705/42

(57) ABSTRACT

An electronic analog of a checkbook provides for instantaneously drafting and transmission of checks and drafts. A user is authenticated by a biometric characteristic or the like. Payees and electronic routing information is stored in a database and used with data input to the device to formulate an electronic draft or check. The electronic check can be transferred to a financial institution via the Internet or other data network to route funds to a payee without having to generate a paper instrument. An alternative embodiment enables checks to be printed directly from the digital checkbook when electronic funds transfers are not possible.

### FIELD OF THE INVENTION

This invention relates to methods and devices for generating, (but not necessarily printing) negotiable instruments. In particular, this invention relates to a method and apparatus allowing paper checks and drafts to be eliminated.

### BACKGROUND OF THE INVENTION

In common parlance, a “check” or “draft” is a document that constitutes an order to a bank (or other depository) by a depositor to pay a sum of money to a certain entity, known as and identified on the face of the check as the “payee.” The entity that writes a check (an order to a bank or other financial institution) is known as the payor; the payee is the entity to whom the bank or other institution is to pay an amount of money. When a payer drafts (writes out) a check and gives it to the payee, the payee can then present the check to the depository, which will thereupon give the payee an amount of money specified on the check out of funds that the payer has on deposit. The payee is required to “endorse” a check by signing the back-side of the document, which is a legal acceptance of the amount tendered by the payer.

Check payees rarely present checks for payment to the institutions on which they are drawn. It is common practice to “cash” or negotiate a check by presenting it to a third party for cash, frequently another bank or financial institution, which issues the sum of money for which the check was written. The entity cashing the check eventually presents the check for payment to the bank or other institution on which it was drawn.

Checks provide a convenient mechanism for directly transferring money between two entities, which is safe (The payee on the face of the check is the only entity that can lawfully cash it.) and widely accepted. A problem with writing a check however is that it time consuming in that the payee name and the amount paid must be written out onto the face of a check. Many consumers write numerous checks each month as part of monthly bill-paying exercise that can become tedious. Having to repeatedly write checks, enter them in a check register each month can be onerous.

Another problem with check writing is that they can become instruments of fraud. A payee has no way of knowing that the payer has funds available, on deposit, to cover a check and is therefore at risk of being cheated or defrauded of goods or services, payment for which was by way of a valueless check or draft. Whether a check is good or bad can't be readily determined, absent a phone call to the institution on which it was drawn and even then, a payer can instruct his depository to dishonor or stop payment on a check.

For these and other reasons, there have been developed so-called debit cards, which look like so-called credit cards but which are used to electronically debit funds from an account of the debit card owner at the time of purchase. Debit cards are promoted and perceived as having certain desirable characteristics: purchases are not made with credit and the ensuing interest charged on unpaid credit card balances; because credit is not used; credit worthiness need not be established in order to obtain a debit card, enabling individuals who don't want to carry cash to be able to make purchases using a compact, credit-card-size device.

### SUMMARY OF THE INVENTION

There is provided herein, a method and apparatus for providing an analog of a checking account embodied as a wireless data terminal that includes a processor to which is coupled, a scanner or other input device by which the digital checkbook operator's identity can be validated. Payee information can be entered through a keyboard or touch sensitive input pad. Software executing on the processor, and data records in the processor or a base station enable electronic funds transfers to the payee using electronic routing information stored in the memory coupled to the processor or to a base station.

### BRIEF DESCRIPTION OF THE DRAWINGS

FIG. 1 shows a simplified block diagram of a system for implementing a wireless digital checkbook.

FIG. 2 is a simplified block diagram of a digital implementation of a checkbook.

FIG. 3 is a depiction of the display of payees on a personal digital assistant that implements a digital checkbook.

FIG. 4 is a simplified flowchart of the steps by which checks and drafts can be processed electronically using a digital checkbook shown in FIG. 3.

FIG. 5 is a simplified flowchart of the methodology performed at a depository upon receipt of a digital check from a depository.

FIG. 6 is a simplified block diagram of the steps performed by a payor depository.

FIG. 7 is a depiction of a digital analogue of a check book and check register.

### DETAILED DESCRIPTION OF THE PREFERRED EMBODIMENT

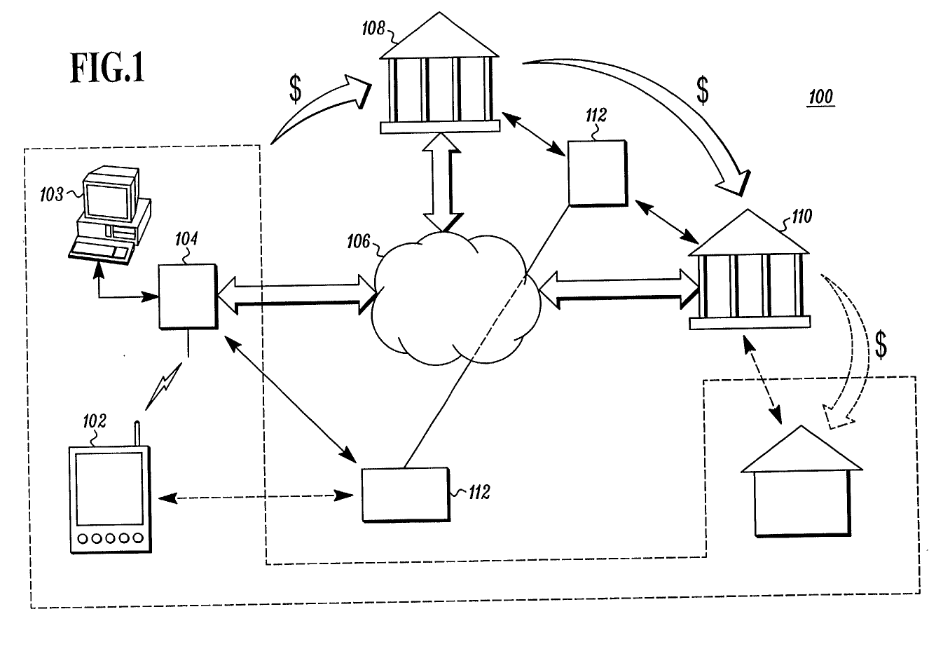

FIG. 1 shows a simplified block diagram of an electronic “check” payment system 100. For purposes of this disclosure, a “check” is a negotiable instrument that is an order to a bank or other entity, to pay a certain amount of money to an entity (the payee) from funds held on deposit. In FIG. 1, a digital checkbook in the form of a personal digital assistant 102 in one embodiment is wirelessly coupled to a base station 104 using a short range wireless communication link, such as a Blue Tooth-compliant protocol allowing the personal digital assistant checkbook 102 to send and receive data to and from the base station 104. (The Blue Tooth specification/protocol for short range wireless communications is available from the official Blue Tooth web site, the address of which is: www.bluetooth.com.) The base station 104 is coupled to a data network 106 to which is coupled a depository such as a bank, or credit union 108 of a person or entity and whereat funds are available for use by the account owner.

In an alternate embodiment, the electronic check book 102 wirelessly communicates with the data network 106 directly, i.e., without the aid of an intermediate base station. Such an embodiment can be readily achieved using two-way communications by cellular telephony and equivalents thereof (e.g., two way paging, two-way trunked radios as well as personal communications service or “PCS” telephones). In yet another embodiment, the digital check book 102 communicates with a bank or other financial institution via the public switched telephone network (PSTN) or other wireline data pathway. Such an embodiment will typically require a wireline data transmitter embodied as a modem by which data signals can be carried through switching systems that carry voice frequency tones. In yet another embodiment, the digital check book communicates over short distances using infra red signals that are broadcast from and received by an appropriate IR interface.

In the preferred embodiment, the data network 106 is the Internet, but the data network 106 can also include private networks (local area networks, i.e., LANs, wide area networks, etc.) or other networks through which data communications can be established between the depository 108 and the digital checkbook 102 directly, or through the base station 104. Those skilled in the art will recognize that communications between the depository 108 and the personal digital assistant-like device 102 that embodies the digital checkbook do not necessarily need to pass through a base station 104. A personal digital assistant equipped with an appropriate wireless communications device, such as cellular telephone, or two-way radio can communicate directly with the depository 108 but can also communicate to the depository 108 through the data network 106, if the personal digital assistant is also equipped with an appropriate data interface, i.e. a modem or network interface by which data could be passed to the network 106 for transmission to the depository there from. By way of example, a PDA equipped with a cellular telephone could call into a banks 108 computer (not shown), log onto the bank's computer and upload to it, an electronic equivalent of a check or draft. The bank's computer can thereafter route the funds to the payee, provided that sufficient information has been provided to the bank on which the check is drawn.

Because data networks like the Internet are readily available to other financial institutions 110, data packets originating from the personal digital assistant 102 or from another data device such as a personal computer 103 operated as a digital checkbook, (which can be considered to be a digital representation of a check) can be easily transferred to, and between, one or more other institutions 110. In other words, data packets from a digital check book (embodied as the PDA) 102 can be sent to a bank or other institution 108 whereat funds of a payor are on deposit, ordering that institution 108 to pay funds to another person or entity through a second financial institution 110 whereat the payee has an account into which funds can be electronically transferred from the first institution 108 to the second institution 110.

An objective of the system 100 depicted in FIG. 1 is to enable financial transactions between a payor and payee using electronic communications between a payor and the payor's depository 108. Electronic financial transactions between a payor and payee require data communications between the first depository (i.e. the payor's bank) or financial institution 108 and a second depository or financial institution 110 (i.e. the payee's bank, which in some instances might be the payor's bank). If both institutions 108, 110 are coupled to the same data network or the Internet 106, communications between them is readily accomplished through either web hosted communications or e-mail.

Those skilled in the art will recognize however that in addition to web hosted or Internet-based communications, it is certainly readily possible to enable communications between a data terminal such as a PDA 102 and a financial institution 108 via other data pathways including the public switched telephone network (PSTN) 112. In such an embodiment, the personal digital assistant 102 or a base station to which it communicates 104 can be coupled to a telephone switching system 112 to which is coupled one or more other institutions such as banks, credit unions or other depositories 108, 110. For purposes of this disclosure, data communications between a terminal device such as a PDA 102 and one or more financial institutions 108, 110 can be equivalently performed via the Internet or the public switched telephone network (PSTN) identified in FIG. 1 by reference numeral 112. In an alternate embodiment where the PDA 102 has access to and can communicate via a telephone network, data communications can be established between the PDA 102 and financial institutions 108, 110.

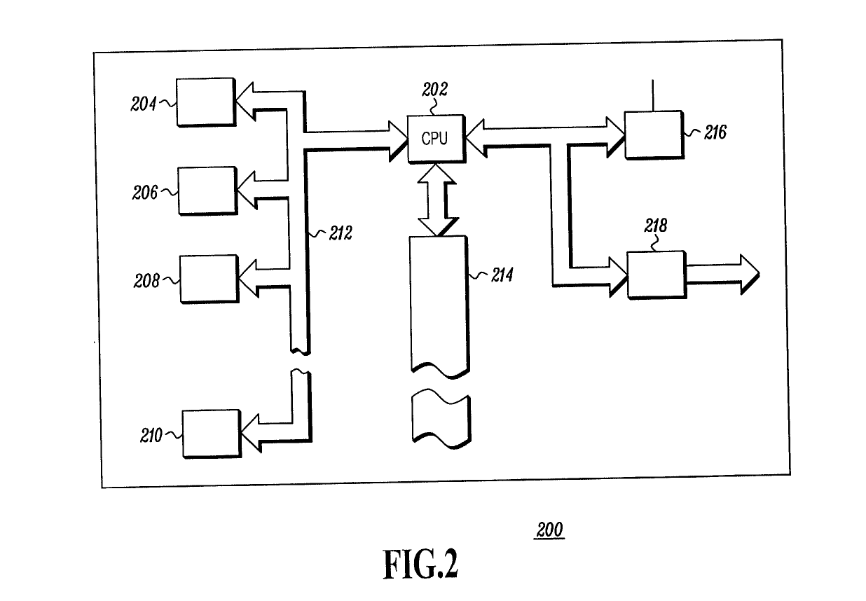

FIG. 2 depicts a simplified block diagram of a personal digital assistant (PDA) device 200 that can perform the functions of a digital checkbook. A central processor 202, (typically a microprocessor, or microcontroller) is operatively coupled to peripheral devices that include a biometric scanner 204, an alphanumeric keypad or keyboard, a mouse or light pen pointing device or other touch sensitive input device 206, a display screen 208 and a terminal or key board 210 via an address, data control bus 212. The central processor unit 202 is also coupled to electronic memory 214, which can include random access memory (RAM), read only memory (ROM), programmable read only memory (PROM), electrically erasable programmable read only memory (EEPROM) and equivalents thereof. Finally, the central processor unit 202 is coupled to a data interface device 216, which in the preferred embodiment is a wireless transceiver through which data signals can be sent to peripheral devices and received there from. The data interface device 216 can take the form of a Blue Tooth-compliant transceiver but also may take the form of a cellular telephone, two-way pager, or two-way radio as well as an Ethernet interface card or modem through which communications can be established via networks such as the public switch telephone network mentioned above.

The biometric scanner 204 might take the form of a retinal scanner or a thumbprint scanner the function of which is principally to authenticate a user or users of the personal digital assistant device 200. Biometric scanners are well known in the art, and are used to accurately identify individuals according to biological characteristics such as fingerprints and retina images. A record of authorized user retinal scans or thumbprint scans can be digitized and stored in memory 214, and, by system 200 software executing on the processor 202, a decision can be made whether a measured biometric characteristic substantially matches a stored representation of a biometric characteristic of an authorized user of the electronic check book. 200. Biometric characteristics of several authorized users can be stored in memory so as to enable different individuals to use the digital checkbook. In so doing, the identity of an individual issuing a check using the electronic check book can be irrefutably established. In the preferred embodiment, biometric authentication is required for each check that is drawn. Alternate embodiments include biometric validation at periodic intervals. Biometric (or password or keyword) validation prevents misappropriation of funds.

Upon authentication of a user, input commands can be received at a touch sensitive screen 206 commonly used on present-day personal digital assistants. The touch sensitive screen 206 has associated with it, input recognition software that runs on the processor 202 and which is also stored in memory 214. Hand writing samples, and special keystrokes are recognized by the processor 202 when input to the device 206 and can include written instructions or signatures commonly used in the process of writing a check or draft.

In addition to a touch sensitive input screen 206, the terminal 200 can also include a keyboard 208 into which characters might be typed using a stylus or keys. Those skilled in the art will recognize that when the terminal 200 takes the form of a personal computer, the input devices depicted in FIG. 2 will include the keyboard, a mouse and a display device, all of which are well known to those skilled in the art and omitted here from for clarity. Finally, the terminal 200 might also include an input voice recognition module 210 into which spoken commands might be entered such as the name of a payee, an address, an amount, and the like.

In writing a check or draft, most states require that certain information be provided as a matter of law. The information required on a negotiable instrument includes the name of the payee, an amount certain to be paid, a signature of the payor, and the date of the order to the institution in which the funds are held on deposit. Absence of any one of these items prevents the check from being lawfully negotiated for payment.

Using either a input touch sensitive pad 206, the keyboard 208, or a microphone and voice recognition software for microphone 210, pertinent data for a negotiable instrument can be entered into the terminal device 200 and formatted for output via either of the data interface 216 or an associated printer through the printer port 218.

In the preferred embodiment, the memory 214 of the terminal device 200 stores is a plethora of data used to accomplish electronic funds transfers. Included in the data stored in memory is a list of payees to which funds are regularly paid, e.g., on a regular monthly basis. By way of example, electronic funds routing information for a mortgagee, car loan holder, utility companies and the like, to which checks are likely written every month, are stored within an electronic data base within the terminal 200. Included with the name of the payee is the electronic data required to direct funds electronically to these payees from a bank 108. Such data will include an electronic routing number as well as an account number required by financial institutions 108, 110 to electronically transfer funds between them.

Also included within memory 214 is a personal financial manager software package such as the Quicken™ financial database manager well known to those skilled in the art. Electronic checks that are prepared by the terminal device 200 by its user, can thereby have financial records that are accessed by a personal financial manager immediately available and updated thereby.

When an electronic funds transfer by check is initiated, written and completed, a multi-byte data package accomplishing the financial transfer can be sent via the data network interface 216 or a printed check can be generated by sending an appropriate data package to the printer interface 218.

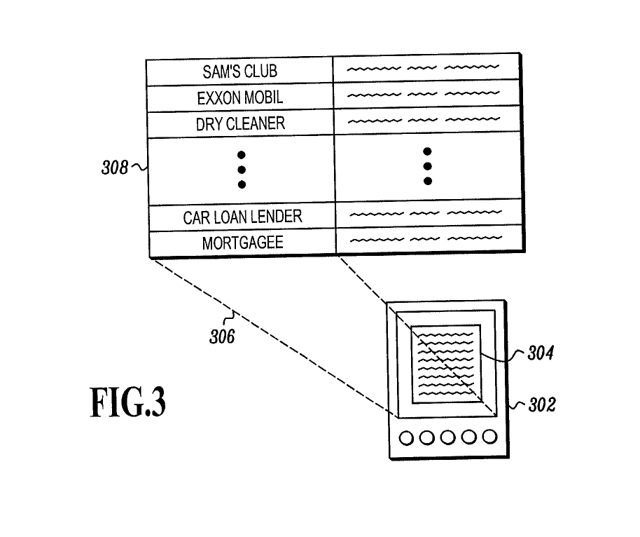

FIG. 3 shows an exemplary depiction of how data might be displayed on the terminal device shown in FIG. 2. In FIG. 3 a personal digital assistant 302 that includes a liquid crystal display screen 304 can display thereon, lists of regular payees 306 to which checks and drafts are frequently or regularly written. Not shown on the display screen 304 of the personal digital assistant 302 is the electronic routing information 308 but which is stored in memory 214 and indexed against the ASCII or plain text representation of the payees. In FIG. 3 a series of potential payees is depicted and include the “Sam's Club,” a car loan lender or mortgagee.

Displaying a list of regular payees, facilitates selection of the payee by a mouse click or stylus keystroke. As set forth hereinafter, once a payee is selected drafting an electronic check is simplified to specifying an amount and date of transfer and authentication.

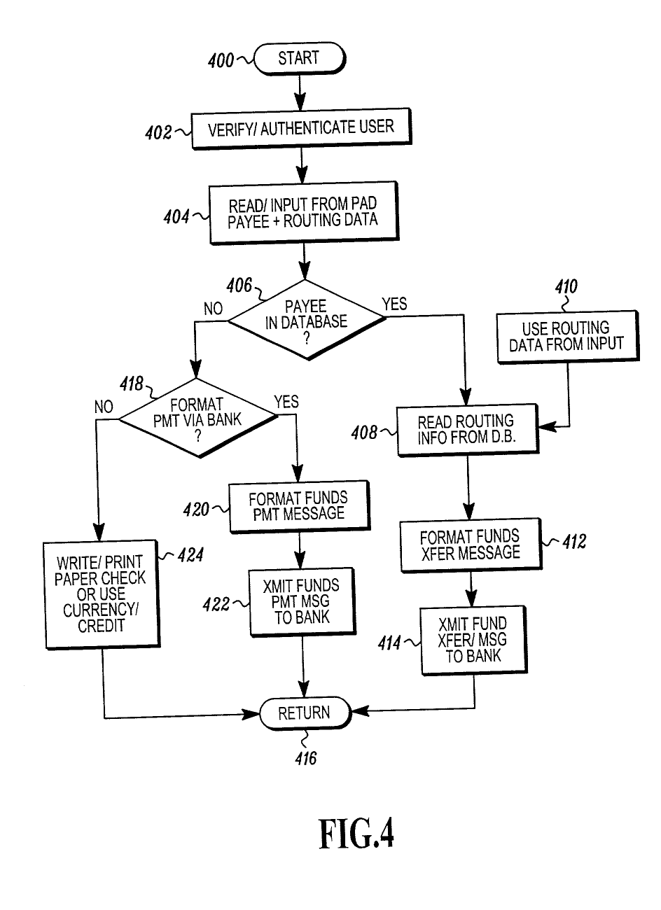

FIG. 4 depicts the steps of a method by which an electronic check can be written and issued. In step 402, the user or operator of the terminal 200 is authenticated or verified, preferably by a biometric scanning device as set forth above. Alternate methodologies might also include however using a key word, multi-digit or multi-character password or passphrase, or using a physical key in the case of computer devices that have physical sizes sufficient to accept a mechanical locking device.

In step 404, the identity of a payee is determined by either scrolling through a list 306 or perhaps typing or writing in the payee's identification. The identity of a payee can be written into a touch sensitive screen, commonly used on personal digital assistants available today. Alternatively, a keyboard or mouse might be used to identify the characters identifying the name of the payee to which the check is to be issued.

If the payee is in a database stored within the terminal 200 or its base station 104 or an associated personal computer 103 to which the base station might be coupled, after the payee is identified, determining a routing number that is required by financial institutions to direct electronic funds transfers becomes a matter of reading the routing information from a database, otherwise, the routing information can be entered directly, if it is available. In step 406, a determination is made whether or not the payee is in a database. Such a database might be stored in memory 214, the base station 104 or a personal computer 103. If the payee is in the database, electronic routing information is read in step 408. In some instances, a payee's name might be in a database but routing information may be need to be input or might need to be changed and in step 410 provision is given to use an electronic routing number input directly into the terminal 200 from the input devices 206 or 208.

After the routing information is established, other legally required information is input to the terminal 200 through the input devices 206 and 208. Such information will include the amount of the check to be issued, the date of the order to the financial institution 108 and an authentication that the instrument is drawn by the account holder.

Authentication was established in step 402 by way of a biometric scanner, password, or key code. Therefore, formulating an electronic negotiable instrument requires only the identification of the payee, a date and the amount. The identity of the payee is preferably established by identifying from a database in step 404. As set forth above, additional payees can have their names entered manually using the touch sensitive screen or keyboard. Electronic routing information for new payees can also be entered by the keypad or touch sensitive screen and added to the database for future use. A date of the order can be established by a clock calendar routing executed by the CPU 202.

In step 412, a funds transfer message is formulated that will include an assemblage of data such as that shown in FIG. 4A. Once the package is assembled it is electronically transferred in step 414 to the financial institution 108, by either a wireless communications protocol (wireless applications protocol, Blue Tooth or the like) using the data interface 216. Control flow returns to the starting point at step 416 for subsequent entries.

In step 406, if a payee is not in the database, in memory 214, the base station 104, a personal computer 103 or even a database of the financial institution 108, a decision must be made whether or not to proceed with issuance of a check using the terminal 200. In step 418, there is provided an alternate procedure by which the terminal 200 can format a message to the financial institution 108 in step 420 by which a check or other negotiable instrument can be made available and retrieved by the payee at the financial institution 108 or delivered by the institution to the payee by U.S. mail or other delivery service. In step 420, an electronic funds transfer message is formulated, much like that performed in step 412 but with the exception that no electronic routing number is provided. Instead, using the identification information of step 404 and 406, a negotiable instrument can be printed by the financial institution 108 and made available for retrieval by transmitting the funds payment message to the bank in step 422.

In step 418, a decision can be made to forgo an electronic funds transfer or electronic funds payment and instead in step 424 print out a check or negotiable instrument from an attached printer via the printer interface 218. Alternatively, a check can be manually written and the check register data in memory updated accordingly. Regardless of the decision in step 418, program control returns at step 416.

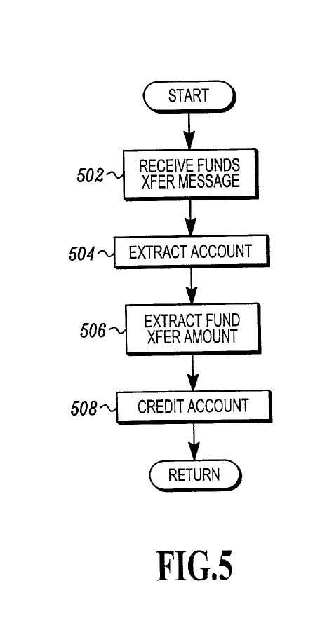

FIG. 5 depicts a simplified flow chart of the steps performed via a financial institution 110 whereat the payee of a negotiable instrument has an account and to which an electronic routing number would be used to direct funds to be paid. In step 502, an electronic funds transfer message from the financial institution 108 (to which the electronic check was directed) is received by the second financial institution 110. In step 504, data in the electronic funds transfer message is extracted, including the account number of the negotiable instrument payee. In step 506, credit for the amount of the check or draft is allocated to the payee's account, which in step 508 is credited to reflect the increase in balance attributable to the amount of the check drafted by the payor in step 404 shown in FIG. 4.

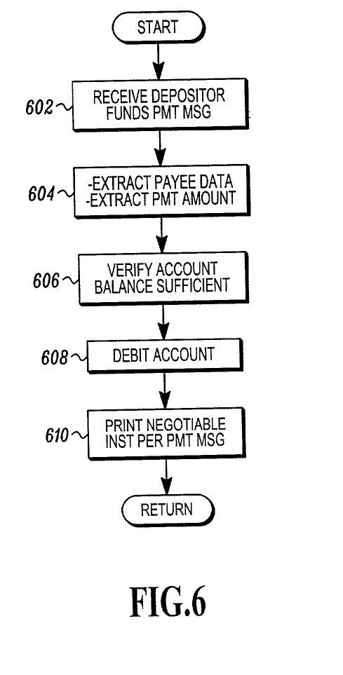

FIG. 6 shows the steps required of the financial institution 108 on which a check or negotiable instrument is drawn by the terminal 200. In step 602, the electronic funds transfer message from the terminal 200 is received. In step 604, the data embedded in that message is extracted and includes the payee's name or electronic routing information, an amount, and an authenticator from the terminal 200. The account balance of the payee is checked to see if sufficient funds are available to make the payment, the account balance is debited by the amount of the instrument in step 608, and in some instances as set forth above, a negotiable instrument can be printed locally at the financial institution for retrieval by the payee, delivery by U.S. Postal Service or other delivery service to the payee in step 610.

Returning to FIG. 1, it can be seen that a personal computer 103 is operatively coupled to the terminal 200. A personal financial software manager program such as the Quicken™ database program will typically execute on a personal computer whereat financial records of an individual or entity might be stored. By appropriate data transfers between the terminal 102 (shown in FIG. 1 but identified in FIG. 2 by reference numeral 200) and the personal computer 103, financial records used by Quicken™ and other financial software can be regularly updated electronically.

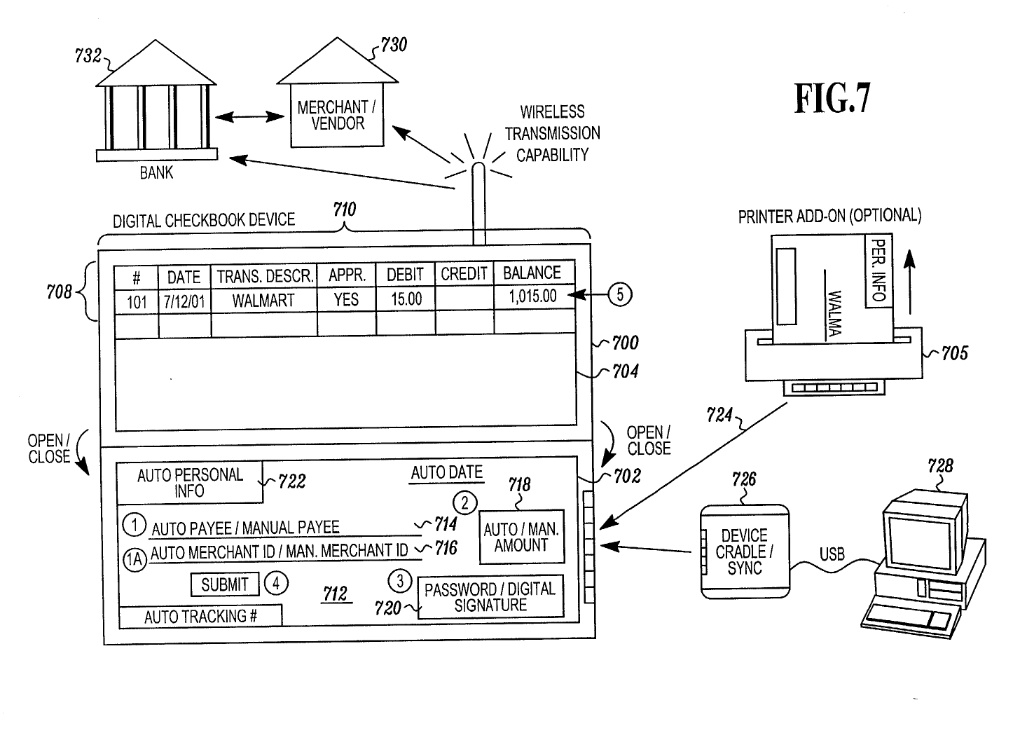

In addition to having electronic financial records updated, it is possible to print negotiable instruments from a printing device attached to either the personal computer 103 or the terminal 102. FIG. 7 depicts an embodiment of a digital check book 700 that replicates both the physical arrangement of a check pad 702 and check register and the functionality of a check book albeit in an electronic analogue.

The check register 704 is preferably a liquid crystal display screen on which several display columns 710 and several display rows 708 display information previously entered into the various fields of a touch-sensitive display screen 712 that has discrete areas for receiving data required for a negotiable instrument.

A payee or payee identifier is electronically “entered” in the payee field 714. The amount of the instrument is “written” (by character input recognition software) into field 716. The date of the instrument is entered into field 718. A password or signature (recognized by character recognition software or a password) is entered into field 720. Information that identifies the payee is entered into space 722.

When information is entered into the above-identified fields of the touch-sensitive display screen, the data entered into the various fields is copied over to the check register display screen 704. The amount of any check that is written is entered into the appropriate column of the check register with the account balance being automatically recalculated and displayed.

A printer interface 724 enables the digital check book 700 to manually print using a printer 705 checks using the data entered on the input screen 702 so that when electronic routing information for a payee is not known, non-existent or unwanted, a negotiable check can be printed directly from the digital check book. In addition, a cradle 726 enables check book data records to be copied over to a personal computer 728.

As with any check book, operation requires entry of a payee using either a pop up menu (displayable on the liquid crystal display screen of the register) or via a keyboard or graphical user interface. Similarly, an amount of the check is entered using a keyboard or graphical user interface. Data representing the payee, date, amount and signature of the payor is wirelessly sent to a merchant or other vendor 730 and subsequently presented to a bank or other financial institution 732 in which the digital check book as a corresponding account.

It should be appreciated from the foregoing, that a truly electronic version of a checkbook can be realized such that checks and drafts drawn on a bank or other financial institution are immediately recognized in an electronic analog of a check register. Automatic deposits and withdrawals made into or from a financial institution 108 can be updated in the database of the terminal 102 and immediately shown in the check register thereof.

By using electronic communications available via the Internet, routine tasks like bill paying using negotiable instruments can be expedited and made more accurate.

We claim:

1. A digital checkbook comprised of:
a processor, executing a control program;
a memory device, operatively coupled to said processor and storing electronic routing information for banking funds;
a biometric scanner, operatively coupled to said processor for authenticating the identity of an individual;
a data input device operatively coupled to said processor capable of receiving input commands and input information;
a wireless data transmitter, operatively coupled to said processor, for sending input commands and input information to a remotely located base station.

2. The digital checkbook of claim 1 wherein said biometric scanner includes at least one of:
a finger print scanner;
a retinal image scanner.

3. The digital checkbook of claim 1 wherein said data input device is comprised of at least one of:
a keypad;
an alphanumeric keyboard;
a touch-sensitive pad;
a pointing device.

4. The digital checkbook of claim 1 wherein said wireless data transmitter is comprised of at least one of:
a Bluetooth protocol-compliant transmitter;
an infrared transmitter.

5. A digital checkbook comprised of:
a processor, executing a control program;
a memory device, operatively coupled to said processor and storing electronic routing information for banking funds;
a biometric scanner, operatively coupled to said processor for authenticating the identity of an individual;
a data input device operatively coupled to said processor capable of receiving input commands and input information;
a wireline data transmitter, operatively coupled to said processor, for sending input commands and input information to a banking institution via a wire line.

6. The digital checkbook of claim 5 wherein said biometric scanner includes at least one of:
a finger print scanner;
a retinal image scanner.

7. The digital checkbook of claim 5 wherein said data input device is comprised of at least one of:
a keypad;
an alphanumeric keyboard;
a touch-sensitive pad;
a pointing device.

8. The digital checkbook of claim 5 wherein said wireless data transmitter is comprised of at least one of:
a Bluetooth protocol-compliant transmitter;
an infrared transmitter.

9. A digital checkbook comprised of:
a processor, executing a control program;
a memory device;
a biometric scanner, operatively coupled to said processor for authenticating the identity of an individual;
a data input device operatively coupled to said processor and receiving therein at least one of:
negotiable instrument payee information;
electronic funds routing information;
a wireless data transmitter, operatively coupled to said processor, for sending input commands and input information to a remotely located base station.

10. The digital checkbook of claim 9 wherein said biometric scanner includes at least one of:
a finger print scanner;
a retinal image scanner.

11. The digital checkbook of claim 9 wherein said data input device is comprised of at least one of:
a keypad;
an alphanumeric keyboard;
a touch-sensitive pad;
a pointing device.

12. The digital checkbook of claim 9 wherein said wireless data transmitter is comprised of at least one of:
a Bluetooth protocol-compliant transmitter;
an infrared transmitter;

13. A method of electronically transferring funds from a payer to a payee comprised of the steps of:
receiving at a data terminal, the name of a payee;
locating electronic funds transfer data for said payee using the name of said payee;
formatting an electronic funds transfer message to a banking institution for said payee;
transmitting said electronic funds transfer message to said banking institution so as to cause an electronic funds transfer from said payer to said payee through said banking institution.

14. The method of claim 13 wherein said step of locating electronic funds transfer data for said payee using the name of said payee includes the steps of:
indexing a data base of payees according to name;
retrieving from said data base, an electronic funds routing number according to the name of said payee;
formatting an electronic funds transfer message using said funds routing number.

15. The method of claim 13 wherein said step of transmitting said electronic funds transfer message includes at least one of:
transmitting said message using a Bluetooth compliant radio system;
transmitting said message using an infrared signal;
transmitting said message using a cellular telephone radio network.

16. A method of electronically transferring funds from a payer to a payee comprised of the steps of:
receiving at a data terminal, at least one of:
the name of a payee;
electronic funds routing information for said payee;
formatting an electronic funds transfer message to a banking institution for said payee;
transmitting said electronic funds transfer message to said banking institution so as to cause an electronic funds transfer from said payer to said payee through said banking institution.

17. The method of claim 16 wherein said step of locating electronic funds transfer data for said payee using the name of said payee includes the steps of:
indexing a data base of payees according to name;
retrieving from said data base, an electronic funds routing number according to the name of said payee;
formatting an electronic funds transfer message using said funds routing number.

18. The method of claim 16 wherein said step of transmitting said electronic funds transfer message includes at least one of:
transmitting said message using a Bluetooth compliant radio system;
transmitting said message using an infrared signal;
transmitting said message using a cellular telephone radio network.
